(19) United States
(12) Patent Application Publication
(10) Pub. No.: US 2026/0212453 A1
(43) Pub. Date: Jul. 23, 2026

(54) METHOD AND SYSTEM FOR NEGATIVE-FILM ILLUMINATION CONTOUR-ENHANCEMENT IMAGING

(71) Applicant: Beijing University of Posts and Telecommunications, Beijing (CN)

(72) Inventors: Yongxiao Li, Beijing (CN); Tingting Zhou, Beijing (CN); Yong Zhang, Beijing (CN); Yue Wu, Beijing (CN)

(21) Appl. No.: 19/325,499

(22) Filed: Sep. 11, 2025

Related U.S. Application Data
(63) Continuation of application No. PCT/CN2025/082009, filed on Mar. 12, 2025.

(30) Foreign Application Priority Data
Jan. 23, 2025 (CN) 2025101119270

(51) Int. Cl. G06T 5/50; G06T 5/70; G06T 5/73

(52) U.S. Cl. CPC G06T 5/50; G06T 5/70; G06T 5/73; G06T 2207/10024; G06T 2207/20221

(57) ABSTRACT

To solve a problem of poor final presentation effect of a negative image, a method and a system for negative-film illumination contour-enhancement imaging are provided, which relates to the field of illumination contour-enhancement imaging technologies. Through automated and optimized image processing procedures, work efficiency is significantly improved. Users are not required to manually perform each step of an optimization process, but can quickly obtain a high-quality optimized image through preset parameters and procedures. The optimized image is saved in a lossless format, which means that no information is lost during a saving process, thereby maintaining the highest image quality. By selecting appropriate algorithms and adjusting parameters, the visual effect of the negative image can be significantly improved, thereby enhancing readability and aesthetic appeal of the negative image. Quality check ensures that a final saved image meets a predetermined quality standard, thereby increasing the reliability and reproducibility of data.

### TECHNICAL FIELD

The disclosure relates to the field of illumination contour-enhancement imaging technologies, and more particularly to a method and a system for negative-film illumination contour-enhancement imaging.

### BACKGROUND

A negative-film is an image obtained after exposure and development processing. Brightness and darkness in the negative-film are opposite to those of a subject, and colors in the negative-film are complementary to colors of the subject. In simple terms, the image seen after developing an exposed film is a reverse-color image, which needs to be enlarged or printed to become an image with the same colors as the subject.

In the related art, there is an inability to enhance contours and details of objects in a negative image through specific lighting and processing methods, thereby resulting in poor negative-film effects. Moreover, there are also the following problems when processing the negative-film.

1. A sample is not illuminated using a more sophisticated method, and an original sample image after illumination is not subjected to further image processing, thereby resulting in poor quality of the original image.

2. The original sample image is not effectively subjected to illumination contour-enhancement processing and fusion processing, thereby resulting in poor image presentation effects.

3. The negative image, after imaging, is not subjected to further optimization and generation, thereby resulting in poor imaging quality.

### SUMMARY

A purpose of the disclosure is to provide a method and a system for negative-film illumination contour-enhancement imaging, which significantly improves work efficiency through automated and optimized image processing procedures. Users are no longer required to manually perform each step of an optimization process. Instead, they can quickly obtain a high-quality optimized image through preset parameters and procedures. The optimized image is saved in a lossless format, which means that no information is lost during a saving process, thereby maintaining the highest image quality. By selecting appropriate algorithms and adjusting parameters, the visual effect of a negative image can be significantly improved, thereby enhancing readability and aesthetic appeal of the image. Quality check ensures that a final saved image meets a predetermined quality standard, thereby increasing the reliability and reproducibility of data. This can address issues present in the related art.

To achieve the above purpose, the disclosure provides the following technical solution: a method for negative-film illumination contour-enhancement imaging, including:

illuminating a sample to obtain an illuminated sample, imaging the illuminated sample through an image sensor to obtain an original sample image, and performing image preprocessing on the original sample image to obtain a preprocessed sample image, where the image preprocessing includes image denoising, contrast adjustment, and image enhancement; and

converting the preprocessed sample image into a negative image, performing illumination contour-enhancement processing on the negative image to highlight image details and thereby obtain an illumination contour-enhancement processed negative image, and fusing the illumination contour-enhancement processed negative image with the original sample image.

In an embodiment, the illuminating a sample to obtain an illuminated sample includes:

selecting the sample before illuminating the sample, where the selecting the sample includes:

collecting, based on a research purpose, samples within a scope of the research purpose, while samples outside the scope of the research purpose being excluded through observation with naked eye or under a microscope;

performing characteristic analysis on the samples within the scope of the research purpose, wherein the characteristic analysis includes optical characteristic analysis and physical characteristic analysis;

performing sample preparation, after the performing characteristic analysis, on the samples within the scope of the research purpose to obtain prepared samples, where the sample preparation includes sample fixation, sample sectioning, and sample staining;

performing sample testing after completion of the performing sample preparation, wherein the sample testing comprises: performing, before the illuminating a sample, an illumination imaging test on some of the prepared samples (i.e., a small-scale illumination imaging test on the prepared samples), and adjusting, based on a result of the illumination imaging test, illumination parameters including intensity, angle and duration; and

determining, based on the result of the illumination imaging test, a sample from the samples within the scope of the research purpose as a selected sample.

In an embodiment, the illuminating a sample to obtain an illuminated sample further includes:

illuminating the selected sample, wherein a process of illuminating the selected sample includes:

selecting an illumination source based on a type of the selected sample and a required resolution of imaging, wherein the illumination source is selected from the group consisting of visible light, ultraviolent light, and X-rays;

setting, based on the characteristic analysis on the selected sample and the result of the illumination imaging test, the illumination parameters including the intensity, the angle, and the duration;

placing the selected sample after being prepared on an illumination platform, activating the illumination source to illuminate the selected sample according to the illumination parameters as set, and simultaneously closely monitoring an illumination situation during a process of the selected sample being illuminated;

immediately shutting off the illumination source after completion of the illuminating, and then performing a preliminary inspection on the illuminated sample with the naked eye or the microscope;

transferring the illuminated sample onto the image sensor for imaging the selected sample; and

recording all of illumination parameters including a type of the illumination source, the intensity, the duration, and a sample position.

In an embodiment, the imaging the illuminated sample through an image sensor to obtain an original sample image includes:

activating the image sensor and previewing image effect of the illuminated sample on the image sensor through software, adjusting imaging parameters until a satisfactory preview image is obtained, and capturing, after confirming that settings of the software are correct, an image of the illuminated sample as a captured sample image; and

performing a quality check on the captured sample image, saving the captured sample image after the quality check in a lossless format as the original sample image, and storing the imaging parameters together with the original sample image, where the imaging parameters include an exposure time, a focal length, and a resolution.

In an embodiment, wherein the performing image preprocessing on the original sample image to obtain a preprocessed sample image includes:

performing the image denoising on the original sample image to obtain a denoised sample image, wherein the image denoising includes:

analyzing a noise type of the original sample image, wherein the noise type is selected from the group consisting of random noise and fixed-pattern noise;

selecting, based on the noise type of the original sample image, a denoising algorithm, where the denoising algorithm is selected from the group consisting of mean filtering, media filtering, and wavelet transform denoising; and

adjusting, based on noise intensity and details of the original sample image, parameters of the denoising algorithm;

performing the contrast adjustment after completion of the imaging denoising to obtain a contrast-adjustment sample image, where the contrast adjustment includes:

performing contrast evaluation on the denoised sample image to obtain an evaluation result, determining, based on the evaluation result, whether the denoised sample image is needed to be adjusted or not, and when the denoised sample image is needed to be adjusted, adjusting the denoised sample image by using a histogram equalization method;

performing the image enhancement after completion of the contrast adjustment, where the image enhancement includes:

enhancing edges of the contrast-adjustment sample image by using a sharpening filter, and then adjusting colors of the contrast-adjustment sample image to obtain an enhanced sample image;

comparing the enhanced sample image with the original sample image to evaluate preprocessing effect;

repeating performing the image preprocessing for adjustment when the preprocessing effect is not within a qualified range.

In an embodiment, the converting the preprocessed sample image into a negative image includes:

loading the preprocessed sample image by using image processing software to obtain a loaded sample image;

reading the loaded sample image including reading a brightness value of each of pixels;

inverting the brightness value of each of the pixels in the loaded sample image to obtain an inverted image; and

saving the inverted image and thereby obtaining the negative image.

In an embodiment, the performing illumination contour-enhancement processing on the negative image includes:

identifying key features in the negative image, and identifying a purpose of the illumination contour-enhancement processing of the negative image, where the purpose of the illumination contour-enhancement processing is selected from the group consisting of edge enhancement, contrast improvement, and highlighting specific structures;

selecting, based on the purpose of the illumination contour-enhancement processing, an illumination contour-enhancement algorithm, where the illumination contour-enhancement algorithm is selected from the group consisting of an edge enhancement algorithm, a local contrast enhancement algorithm, and a wavelet-based contour-enhancement algorithm;

previewing a change of the negative image in real-time during the illumination contour-enhancement processing to obtain a preview result, and adjusting, based on the preview result, parameters of the illumination contour-enhancement algorithm; and

completing the illumination contour-enhancement processing of the negative image.

In an embodiment, the fusing the illumination contour-enhancement processed negative image with the original sample image includes:

unifying a resolution and a size of the illumination contour-enhancement processed negative image with a resolution and a size of the original sample image;

performing image fusion by using a multi-resolution fusion method after completion of the unifying, wherein the image fusion comprises:

performing wavelet transform on the illumination contour-enhancement processed negative image and the original sample image to decompose each of the illumination contour-enhancement processed negative image and the original sample image into sub-images of different frequencies, selecting the sub-images with designated frequencies for fusion, and then performing inverse transform to obtain a fused image;

previewing fusion effect during the image fusion, and adjusting, based on the fusion effect, fusion parameters including a weight and a transparency; and

ultimately obtaining a fused sample image.

A system for negative-film illumination contour-enhancement imaging, includes:

a fused image optimization unit, configured to optimize the fused sample image by performing optimization steps to thereby obtain an optimized image, and configured to save the optimized image in a lossless format and record parameters of all of the optimization steps to thereby obtain a final optimized image, where the optimization steps include: contrast optimization, color balance, sharpening, denoising, brightness adjustment, detail enhancement, and image cropping and rotation.

In an embodiment, the system for negative-film illumination contour-enhancement imaging further includes:

an optimized image generation unit, configured to generate a resultant image from the final optimized image, determine generation parameters before the resultant image is generated, and obtain the resultant image corresponding to the final optimized image after the generation parameters are determined, where the generation parameters comprise an output format, an image resolution, and a color mode.

Compared to the related art, the disclosure may achieve the following beneficial effects.

1. The method and the system for negative-film illumination contour-enhancement imaging provided by the disclosure adjust the parameters of the denoising algorithm based on the noise intensity and the details of the original sample image. This ensures that the processed result removes noise while maintaining the clarity and details of the original sample image. The quality check ensures that the finally saved image meets the predetermined quality standards, thereby improving the reliability and reproducibility of the data. The illumination parameters are adjusted according to the result of the illumination imaging test to ensure the accuracy of the illumination process and the optimization of the imaging effect.

2. The method and the system for negative-film illumination contour-enhancement imaging provided by the disclosure employ the multi-resolution fusion method, which enables the full utilization of image information across different scales. This method facilitates the capture and integration of detailed information within the image. By selecting the appropriate algorithm and adjusting parameters, the visual quality of the negative image can be significantly enhanced, thereby improving the readability and aesthetic appeal of the image. In addition, by inverting the brightness values, originally bright regions become dim, while dim regions become bright. This transformation often reveals details in the original image that are not readily noticeable.

3. The method and the system for negative-film illumination contour-enhancement imaging provided by the disclosure significantly enhance the work efficiency through the automated and optimized image processing procedures. The users are not required to manually perform each step of the optimization process, but can quickly obtain the high-quality optimized image through the preset parameters and procedures. The optimized image is saved in the lossless format, which means that no information is lost during the saving process, thereby maintaining the highest image quality.

### BRIEF DESCRIPTION OF DRAWINGS

FIG. 1 illustrates a schematic diagram of steps of negative-film illumination contour-enhancement imaging of the disclosure.

FIG. 2 illustrates a flowchart of the negative-film illumination contour-enhancement imaging of the disclosure.

### DETAILED DESCRIPTION OF EMBODIMENTS

Below, technical solutions in embodiments of the disclosure will be clearly and completely described in conjunction with attached drawings. Obviously, described embodiments are merely a part of the embodiments of the disclosure and not all of them. Based on the embodiments of the disclosure, all other embodiments obtained by those skilled in the art without creative labor are also within the scope of protection of the disclosure.

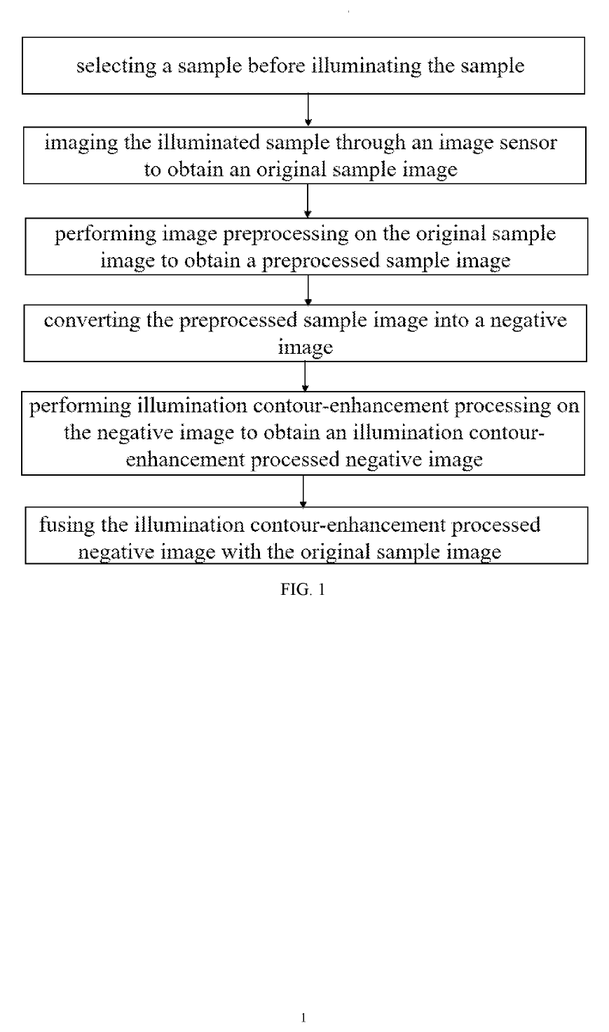

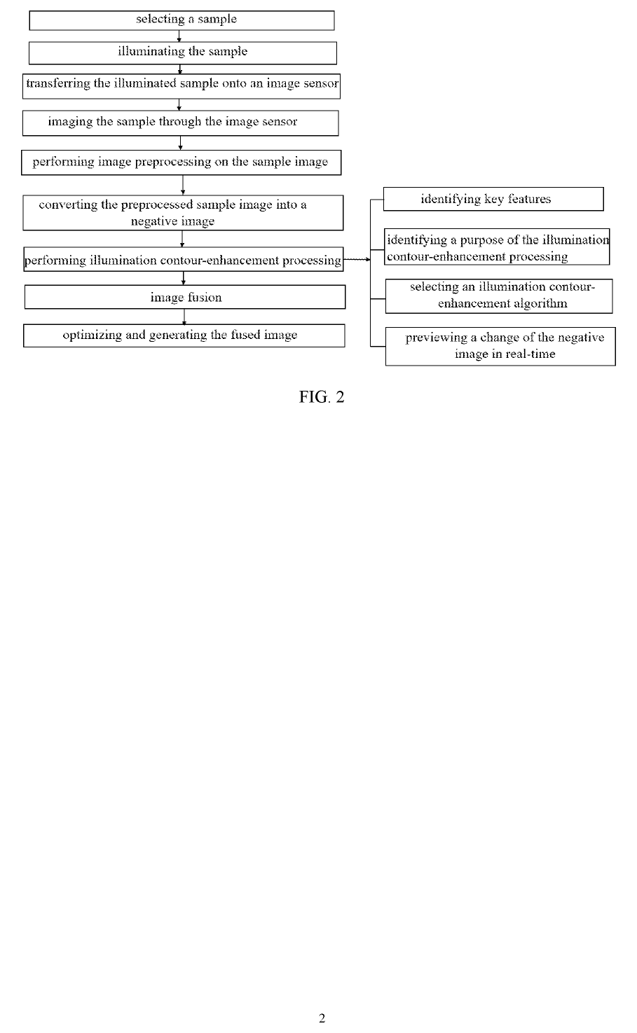

To solve a problem of poor quality of an original sample image caused by the lack of a more sophisticated illumination method for a sample and the absence of further image processing for a sample image after illumination in the related art, as shown in FIGS. 1 and 2, an embodiment of the disclosure provides the following technical solution.

The embodiment of the disclosure provides a method for negative-film illumination contour-enhancement imaging, and specific operations of this method are as follows. A sample is illuminated to obtain an illuminated sample. The illuminated sample is imaged through an image sensor to obtain an original sample image. The original sample image is subjected to image preprocessing to obtain a preprocessed sample image, and the image preprocessing includes image denoising, contrast adjustment, and image enhancement. The preprocessed sample image is converted into a negative image. The negative image is subjected to illumination contour-enhancement processing to highlight image details and thereby obtain an illumination contour-enhancement processed negative image. The illumination contour-enhancement processed negative image is fused with the original sample image.

Specifically, steps of the image preprocessing (image denoising, contrast adjustment and image enhancement) can significantly improve the overall quality of an image, making the image clearer and richer in detail, thereby laying a solid foundation for subsequent processing and analysis. Then the original sample image is converted into the negative image and then subjected to the illumination contour-enhancement processing, which further highlights the details in the original sample image. Negative processing, as an image inversion technique, reveals information in the original sample image that is not readily apparent. The illumination contour-enhancement processing enhances lighting and shadow effects in the negative image through specific algorithms or techniques, making the details more distinct. By fusing the illumination contour-enhancement processed negative image with the original sample image, information advantages of both can be integrated. This fusion not only retains key information in the original sample image but also introduces the highlighted details in the negative image, thereby increasing the overall information content and readability of the image. Through a series of refined image processing steps, the clarity and detail visibility of the image can be significantly improved, thereby enabling professionals to more accurately diagnose and analyze the sample. An entire processing procedure can be automated through computer programs, reducing the complexity and errors associated with manual operations. This not only increases processing efficiency but also ensures consistency and stability of processing results.

Before the sample is illuminated, the sample is selected. The selection of the sample includes the following specific operations. First, based on a research purpose, samples within a scope of the research purpose are collected, while samples outside the scope of the research purpose are excluded through observation with naked eye or under a microscope. Then the samples within the scope of the research purpose are subjected to characteristic analysis, and the characteristic analysis includes optical characteristic analysis and physical characteristic analysis. After the characteristic analysis, the samples within the scope of the research purpose are subjected to sample preparation to obtain prepared samples, and the sample preparation includes sample fixation, sample sectioning, and sample staining. After completion of the sample preparation, sample testing is performed. The sample testing includes performing a small-scale illumination imaging test on the prepared samples (i.e., an illumination imaging test on some of the prepared samples) before the sample is illuminated, and adjusting, illumination parameters including intensity, angle and duration based on a result of the small-scale illumination imaging test. Finally, based on the result of the small-scale illumination imaging test, a sample is selected from the samples within the scope of the research purpose as a selected sample.

The selected sample is illuminated, and a process of illuminating the selected sample is as follows. First, an illumination source is selected based on a type of the selected sample and a required resolution of imaging, and the illumination source is selected from the group consisting of visible light, ultraviolet light, and X-rays. Based on the characteristic analysis on the selected sample and the result of the small-scale illumination imaging test, the illumination parameters including the intensity, the angle and the duration are set. Then, the selected sample after being prepared is placed on an illumination platform, and the illumination source is activated to illuminate the selected sample according to the illumination parameters as set. Simultaneously, during a process of the selected sample being illuminated, an illumination situation is closely monitored. After completion of the illumination, the illumination source is immediately shut off, and the illuminated sample is subjected to a preliminary inspection with the naked eye or the microscope. Then the illuminated sample is transferred onto the image sensor for imaging the selected sample, and all of illumination parameters including a type of the illumination source, the intensity, the duration and a sample position are recorded.

Specifically, sample selection is first based on the research purpose to ensure that the selected sample is closely related to a research topic, improving the pertinence and efficiency of the study. The samples that do not meet the requirements (i.e., the samples outside the scope of the research purpose) are excluded through observation with the naked eye or under the microscope, ensuring the preliminary quality of the samples. The samples within the scope of the research purpose are then subjected to the characterization analysis, including the optical characteristic analysis and the physical characteristic, which aids in more accurately understanding sample characteristics and provides a foundation for subsequent illumination and imaging. The sample preparation process includes sample fixation, sample sectioning and sample staining, which improve the imaging clarity and contrast of the samples within the scope of the research purpose. Prior to formal illumination, the small-scale illumination imaging test is performed on the prepared samples. Based on the result of this test, the illumination parameters are adjusted to ensure the precision of the illumination process and the optimization of imaging outcomes. The illumination source is selected based on the type of the selected sample and the required resolution of imaging, which demonstrates the flexibility and adaptability of the method. The illumination parameters are set and strictly controlled to ensure consistency and stability throughout the illumination process. During the illumination process, close monitoring is performed to promptly identify and address any potential issues, thereby ensuring the safety and effectiveness of the illumination process. The immediate preliminary inspection is performed after illumination to detect and correct any possible problems in a timely manner, ensuring imaging quality. The illuminated sample is then transferred to the image sensor for imaging, which provides the basis for subsequent image analysis and research. All of the illumination parameters are meticulously recorded, facilitating the traceability and analysis of the illumination process and serving as a reference for future research.

The illuminated sample is subjected to imaging through the image sensor to obtain the original sample image, which includes the following specific operations. The image sensor is activated and imaging effect of the illuminated sample on the image sensor is previewed through software. Imaging parameters are adjusted until a satisfactory preview image is obtained, and whether the satisfactory is obtained is determined based on requirements of a user After confirming that settings of the software are correct, an image of the illuminated sample is captured as a captured sample image, and the settings of the software include a contrast setting for the captured sample image and parameter settings chosen by the user Then, the captured sample image is subjected to a quality check. After the quality check, the captured sample image is saved in a lossless format as the original sample image. The imaging parameters, including an exposure time, a focal length, and a resolution, are saved together with the original sample image.

Specifically, before capturing the image of the illuminated sample, users can preview the imaging effect of the illuminated sample on the image sensor through the software. This preview function allows the users to adjust the imaging parameters in real-time, such as the exposure time, the focal length, and the resolution, ensuring an optimal imaging result before capturing the image of the illuminated sample. By previewing and adjusting, the users can avoid spending a lot of time and resources on correcting image quality in post-processing, improving work efficiency. The quality check of the captured sample image is an important step in ensuring image accuracy and completeness. This helps identify and correct any possible imaging issues, such as blurring, underexposure, or overexposure. The quality check ensures that the final saved image meets the predetermined quality standard, thereby improving the reliability and repeatability of the data. Saving the captured sample image after the quality check in the lossless format as the original sample image ensures that no information or quality is lost during the storage and transmission process. The image saved in the lossless format has higher accuracy and reliability in subsequent analysis and processing, which helps to avoid data loss or errors. Saving the imaging parameters (including the exposure time, the focal length, and the resolution) together with the original sample image is crucial for subsequent image analysis and processing. These imaging parameters provide detailed information about the image capture conditions, help explain any anomalies or features in the image, and enhance the traceability and interpretability of the data.

The original sample image is subjected to the image preprocessing to obtain the preprocessed sample image, including the following specific operations. First, the original sample image is subjected to the image denoising to obtain a denoised sample image, which includes: analyzing a noise type of the original sample image, where the noise type is selected from the group consisting of random noise and fixed-pattern noise; selecting a denoising algorithm based on the noise type of the original sample image, where the denoising algorithm is selected from the group consisting of mean filtering, median filtering, and wavelet transform denoising; and adjusting parameters of the denoising algorithm based on noise intensity and details of the original sample image. After completion of the image denoising, the contrast adjustment is performed to obtain a contrast-adjustment sample image, which includes: performing contrast evaluation on the denoised sample image to obtain an evaluation result, determining whether the denoised sample image is needed to be adjusted or not based on the evaluation result, and if the denoised sample image is needed to be adjusted, adjusting the denoised sample image by using a histogram equalization method. After completion of the contrast adjustment, the image enhancement is performed, which includes: enhancing edges of the contrast-adjustment sample image by using a sharpening filter, and then adjusting colors of the contrast-adjustment sample image to obtain an enhanced sample image. Then, the enhanced sample image is compared with the original sample image to evaluate preprocessing effect. When the preprocessing effect is not within a qualified range, the image preprocessing is repeated for adjustment. The qualified range means the photon count by a camera is within a user-defined scale bar, ranging from 0-255 per pixel, that’s to say, the qualified range is defined by the user.

Specifically, the noise type in the image (random noise or fixed pattern noise) is analyzed to select the most suitable denoising algorithm (such as mean filtering, median filtering, or wavelet transform denoising). This targeted treatment more effectively reduces noise while preserving important image details. The parameters of the denoising algorithm are adjusted according to the noise intensity and the details of the image, ensuring that the noise is removed while maintaining the clarity and detail of the image. Contrast evaluation and adjustment steps are taken to improve the visual effect of the image, making the information within the image clearer and more distinguishable. The histogram equalization method is an effective contrast enhancement technique applicable to various types of images. The image edges are enhanced by using the sharpening filter, which strengthens the details and structure of the image. Color adjustments correct color deviations in the image, enhancing the overall image quality. The preprocessed sample image is compared with the sample image to visually assess the effect of preprocessing. This evaluation mechanism helps ensure the effectiveness of the preprocessing steps and allows for necessary adjustments. If the preprocessing effect is not within the qualified range, the process allows for repetition of the above steps for adjustment. This iterative optimization process ensures that the final image quality meets specific requirements.

To solve a problem of poor image presentation caused by the lack of effective illumination contour-enhancement processing and fusion processing of the original sample image in the related art, as shown in FIGS. 1 and 2, another embodiment of the disclosure provides the following technical solution.

The preprocessed sample image is converted into the negative image, which includes the following specific operations. First, the preprocessed sample image is loaded by using image processing software to obtain a loaded sample image. The loaded sample image is read, which includes reading a brightness value of each of pixels. Then, the brightness value of each of the pixels in the loaded sample image is inverted to obtain an inverted image. Finally, the inverted image is saved, resulting in the negative image.

Specifically, the above process mainly depends on the basic functions of the image processing software, such as image loading, pixel value reading, and image saving. The operation of reversing pixel values is relatively simple, usually achieved through built-in functions in programming languages or simple operations in image processing libraries. Since the processing of each pixel is independent and the operation (reversing brightness values) is relatively simple, the entire processing process can be very fast. This is particularly advantageous for an application scenario that require rapid processing of a large number of images. The negative image has a sharp contrast effect visually and is commonly used in fields such as art processing, scientific research, or medical diagnosis. By reversing the brightness values, previously bright areas become dull, while dull areas become bright. This change often reveals subtle details in the original image and can be applied to various types of images, whether they are color or grayscale images. The negative image can be generated by reversing pixel values. In addition, this solution can also be combined with other image processing techniques to further enrich the means of image processing.

The negative image is subjected to the illumination contour-enhancement processing, which includes the following specific operations. First, key features in the negative image are identified, and a purpose of the illumination contour-enhancement processing of the negative image is also identified. The purpose of the illumination contour-enhancement processing is selected from the group consisting of edge enhancement, contrast improvement, and highlighting specific structures. Then, an illumination contour-enhancement algorithm is selected based on the purpose of the illumination contour-enhancement processing, and the illumination contour algorithm is selected from the group consisting of an edge enhancement algorithm, a local contrast enhancement algorithm, and a wavelet-based contour-enhancement algorithm. During the illumination contour-enhancement processing, a change of the negative image is previewed in real-time to obtain a preview result, and parameters of the illumination contour-enhancement algorithm are adjusted based on the preview result. Finally, the illumination contour-enhancement processing of the negative image is completed.

Specifically, the key features in the negative image are first identified, ensuring that subsequent processing can optimize important information in the negative image. Based on the processing purpose (such as enhancing edges, improving contrast, or highlighting specific structures), the specific illumination contour-enhancement algorithm is selected. This targeted processing can more effectively achieve the expected visual effect. Multiple illumination contour-enhancement algorithms are provided for selection, including the edge enhancement algorithm, the local contrast enhancement algorithm, and the wavelet based contouring algorithm. This increases the flexibility of processing and allows for the selection of appropriate algorithms according to different image characteristics and processing requirements. Real time preview of the change of the negative image during processing allows for adjustment of algorithm parameters based on the preview result. This real-time feedback mechanism makes the processing more intuitive and controllable. By selecting the appropriate algorithm and adjusting parameters, the visual effect of the negative image can be significantly improved, such as enhancing edge clarity, improving overall contrast, or highlighting specific structures, thereby improving image readability and aesthetics. From key feature confirmation to algorithm selection, parameter adjustment, and final processing completion, the entire process is organized, easy to understand, and operate. The real-time preview function allows the users to intuitively see the processing effect, simplifying the process of parameter adjustment and reducing operational difficulty.

The illumination contour-enhancement processed negative image is fused with the original sample image, which includes the following specific operations. First, a resolution and a size of the illumination contour-enhancement processed negative image are unified with a resolution and a size of the original sample image. After completion of unification, image fusion is performed by using a multi-resolution fusion method, and the image fusion includes: performing wavelet transform on the illumination contour-enhancement processed negative image and the original sample image to decompose each of the illumination contour-enhancement processed negative image and the original sample image into sub-images of different frequencies (including low frequency, medium frequency, and high frequency), selecting the sub-images with designated frequencies (including the sub-images with low-frequency and high-frequency) for fusion, and then performing inverse transform to obtain a fused image. During the image fusion, fusion effect is previewed, and fusion parameters, including a weight and a transparency, are adjusted based on the preview effect. Ultimately, a fused sample image is obtained.

Specifically, the resolution and size of the illumination contour-enhancement processed negative image are unified with the resolution and the size of the original sample image to ensure the fundamental consistency of the fusion process. This is an essential prerequisite for image fusion, preventing image distortion or poor fusion results due to mismatched dimensions or resolution. The multi-resolution fusion method is employed to fully utilize the information of the image at different scales. This method helps to capture and integrate detailed information in the image, enhancing the clarity and detail expression of the fused image. Wavelet transform, an effective image decomposition tool, is used to decompose the image into sub-images of different frequencies. This step allows for finer control over the sub-images with low-frequency and high-frequency during the fusion process, thereby optimizing the fusion effect. The low-frequency sub-image typically represent the main structure and contours of the image, while the high-frequency sub-image contain the details and texture information. During the fusion process, the fusion effect is previewed, and the parameters such as the weight and transparency are adjusted based on the fusion effect. This flexibility ensures that the final fused image meets specific visual requirements and application needs. Through the aforementioned steps, the final fused image combines the information of the illumination contour-enhancement processed negative image and the characteristics of the original sample image. This enhances certain specific aspects of the image (such as clarity, contrast, etc.) while preserving the original image information. It helps to improve the overall quality of the image, making it more suitable for subsequent analysis, processing, or display.

To solve a problem of poor imaging quality caused by the lack of further image optimization and generation of the negative image after imaging in the related art, as shown in FIGS. 1 and 2, still another embodiment of the disclosure provides the following technical solution.

Still another embodiment of the disclosure provides a system for negative-film illumination contour-enhancement imaging, which includes a fused image optimization unit. The fused image optimization unit is configured to optimize the fused sample image by performing optimization steps to thereby obtain an optimized image. The fused image optimization unit is also configured to save the optimized image in a lossless format and record parameters of all of the optimization steps to thereby obtain a final optimized image. The optimization steps include contrast optimization, color balance, sharpening, denoising, brightness adjustment, detail enhancement, and image cropping and rotation.

The system for negative-film illumination contour-enhancement imaging further includes an optimized image generation unit. The optimized image generation unit is configured to generate a resultant image from the final optimized image, determine generation parameters before the resultant image is generated, and obtain the resultant image corresponding to the final optimized image after the generation parameters are determined. The generation parameters include an output format, an image resolution, and a color mode.

In an embodiment, each of the fused image optimization unit and the optimized image generation unit is embodied by at least one processor and at least one memory coupled to the at least one processor, and the at least one memory stores computer programs executable by the at least one processor.

Specifically, the fused image optimization unit performs various optimization processes on the fused sample image, including contrast optimization, color balance, sharpening, noise reduction, brightness adjustment, detail enhancement, and image cropping and rotation. These steps together ensure the best visual performance of the fused sample image, resulting in significant improvements in clarity, color accuracy, and overall aesthetics. The optimized image is saved in lossless format, which means that no information is lost during the saving process, maintaining the highest image quality. At the same time, recording the parameters of all of the optimization steps helps to trace and reproduce the image processing flow in the future, and also facilitates the optimization and comparison of image processing effects. The optimized image generation unit allows for the determination of the generation parameters before generating the resultant image, and these parameters include the output format, the image resolution, and the color mode. This flexibility ensures that the resultant image can be adjusted according to different needs and application scenarios, thus meeting diverse usage requirements. Through the optimized image generation unit, it can ensure that the final output image (i.e., the resultant image) achieves optimal quality. Whether used for printing, online publishing, or other purposes, it can provide clear, accurate, and colorful image effects, significantly improving work efficiency through automated and optimized image processing procedures. Users do not need to manually perform each step of the optimization process, but can quickly obtain high-quality optimized image through preset parameters and processes. By recording and saving the parameters of the optimization steps, this solution helps to achieve standardization and normalization of image processing. This helps ensure consistency and comparability of images processed between different times and personnel.

It should be noted that in this text, relational terms such as “first” and “second” are used solely to distinguish one entity or operation from another, and do not necessarily imply any actual relationship or sequence between these entities or operations. Moreover, terms “including”, “containing” or any other variants are intended to cover non-exclusive inclusion, such that a process, a method, an article, or an apparatus that includes a series of elements not only includes those elements but also includes other elements not explicitly listed, or may include inherent elements of such process, method, article, or apparatus.

Although embodiments of the disclosure been shown and described, it is understood by those skilled in the art that various changes, modifications, substitutions, and variations can be made to these embodiments without departing from the principles and spirit of the disclosure.

What is claimed is:

1. A method for negative-film illumination contour-enhancement imaging, comprising:
illuminating a sample to obtain an illuminated sample, imaging the illuminated sample through an image sensor to obtain an original sample image, and performing image preprocessing on the original sample image to obtain a preprocessed sample image, wherein the image preprocessing comprises image denoising, contrast adjustment, and image enhancement; and
converting the preprocessed sample image into a negative image, performing illumination contour-enhancement processing on the negative image to highlight image details and thereby obtain an illumination contour-enhancement processed negative image, and fusing the illumination contour-enhancement processed negative image with the original sample image.

2. The method for negative-film illumination contour-enhancement imaging as claimed in claim 1, wherein the illuminating a sample to obtain an illuminated sample comprises:
selecting the sample before illuminating the sample, wherein the selecting the sample comprises:
collecting, based on a research purpose, samples within a scope of the research purpose, while samples outside the scope of the research purpose being excluded through observation with naked eye or under a microscope;
performing characteristic analysis on the samples within the scope of the research purpose, wherein the characteristic analysis comprises optical characteristic analysis and physical characteristic analysis;
performing sample preparation, after the performing characteristic analysis, on the samples within the scope of the research purpose to obtain prepared samples, wherein the sample preparation comprises sample fixation, sample sectioning, and sample staining;
performing sample testing after completion of the performing sample preparation, wherein the sample testing comprises: performing, before the illuminating a sample, an illumination imaging test on some of the prepared samples, and adjusting, based on a result of the illumination imaging test, illumination parameters including intensity, angle and duration; and
determining, based on the result of the illumination imaging test, a sample from the samples within the scope of the research purpose as a selected sample.

3. The method for negative-film illumination contour-enhancement imaging as claimed in claim 2, wherein the illuminating a sample to obtain an illuminated sample further comprises:
illuminating the selected sample, wherein a process of illuminating the selected sample comprises:
selecting an illumination source based on a type of the selected sample and a required resolution of imaging, wherein the illumination source is selected from the group consisting of visible light, ultraviolet light, and X-rays;
setting, based on the characteristic analysis on the selected sample and the result of the illumination imaging test, the illumination parameters including the intensity, the angle and the duration;
placing the selected sample after being prepared on an illumination platform, activating the illumination source to illuminate the selected sample according to the illumination parameters as set, and simultaneously closely monitoring an illumination situation during a process of the selected sample being illuminated;
immediately shutting off the illumination source after completion of the illuminating, and then performing a preliminary inspection on the illuminated sample with the naked eye or the microscope;
transferring the illuminated sample onto the image sensor for imaging the selected sample; and
recording all of illumination parameters including a type of the illumination source, the intensity, the duration, and a sample position.

4. The method for negative-film illumination contour-enhancement imaging as claimed in claim 1, wherein the imaging the illuminated sample through an image sensor to obtain an original sample image comprises:
activating the image sensor and previewing imaging effect of the illuminated sample on the image sensor through software, adjusting imaging parameters until a satisfactory preview image is obtained, and capturing, after confirming that settings of the software are correct, an image of the illuminated sample as a captured sample image; and
performing a quality check on the captured sample image, saving the captured sample image after the quality check in a lossless format as the original sample image, and storing the imaging parameters together with the original sample image, wherein the imaging parameters comprise an exposure time, a focal length, and a resolution.

5. The method for negative-film illumination contour-enhancement imaging as claimed in claim 1, wherein the performing image preprocessing on the original sample image to obtain a preprocessed sample image comprises:
performing the image denoising on the original sample image to obtain a denoised sample image, wherein the image denoising comprises:
analyzing a noise type of the original sample image, wherein the noise type is selected from the group consisting of random noise and fixed-pattern noise;
selecting, based on the noise type of the original sample image, a denoising algorithm, wherein the denoising algorithm is selected from the group consisting of mean filtering, median filtering, and wavelet transform denoising; and
adjusting, based on noise intensity and details of the original sample image, parameters of the denoising algorithm;
performing the contrast adjustment after completion of the image denoising to obtain a contrast-adjustment sample image, wherein the contrast adjustment comprises:
performing contrast evaluation on the denoised sample image to obtain an evaluation result, determining, based on the evaluation result, whether the denoised sample image is needed to be adjusted or not, and when the denoised sample image is needed to be adjusted, adjusting the denoised sample image by using a histogram equalization method;
performing the image enhancement after completion of the contrast adjustment, wherein the image enhancement comprises:
enhancing edges of the contrast-adjustment sample image by using a sharpening filter, and then adjusting colors of the contrast-adjustment sample image to obtain an enhanced sample image;
comparing the enhanced sample image with the original sample image to evaluate preprocessing effect;
repeating performing the image preprocessing for adjustment when the preprocessing effect is not within a qualified range.

6. The method for negative-film illumination contour-enhancement imaging as claimed in claim 1, wherein the converting the preprocessed sample image into a negative image comprises:
loading the preprocessed sample image by using image processing software to obtain a loaded sample image;
reading the loaded sample image including reading a brightness value of each of pixels;
inverting the brightness value of each of the pixels in the loaded sample image to obtain an inverted image; and
saving the inverted image and thereby obtaining the negative image.

7. The method for negative-film illumination contour-enhancement imaging as claimed in claim 1, wherein the performing illumination contour-enhancement processing on the negative image comprises:
identifying key features in the negative image, and identifying a purpose of the illumination contour-enhancement processing of the negative image, wherein the purpose of the illumination contour-enhancement processing is selected from the group consisting of edge enhancement, contrast improvement, and highlighting specific structures;
selecting, based on the purpose of the illumination contour-enhancement processing, an illumination contour-enhancement algorithm, wherein the illumination contour-enhancement algorithm is selected from the group consisting of an edge enhancement algorithm, a local contrast enhancement algorithm, and a wavelet-based contour-enhancement algorithm;
previewing a change of the negative image in real-time during the illumination contour-enhancement processing to obtain a preview result, and adjusting, based on the preview result, parameters of the illumination contour-enhancement algorithm; and
completing the illumination contour-enhancement processing of the negative image.

8. The method for negative-film illumination contour-enhancement imaging as claimed in claim 7, wherein the fusing the illumination contour-enhancement processed negative image with the original sample image comprises:
unifying a resolution and a size of the illumination contour-enhancement processed negative image with a resolution and a size of the original sample image;
performing image fusion by using a multi-resolution fusion method after completion of the unifying, wherein the image fusion comprises:
performing wavelet transform on the illumination contour-enhancement processed negative image and the original sample image to decompose each of the illumination contour-enhancement processed negative image and the original sample image into sub-images of different frequencies, selecting the sub-images with designated frequencies for fusion, and then performing inverse transform to obtain a fused image;
previewing fusion effect during the image fusion, and adjusting, based on the fusion effect, fusion parameters including a weight and a transparency; and
ultimately obtaining a fused sample image.

9. A system for negative-film illumination contour-enhancement imaging, applying into the method for negative-film illumination contour-enhancement imaging as claimed in claim 8 and comprising:
a fused image optimization unit, configured to optimize the fused sample image by performing optimization steps to thereby obtain an optimized image, and configured to save the optimized image in a lossless format and record parameters of all of the optimization steps to thereby obtain a final optimized image, wherein the optimization steps comprise: contrast optimization, color balance, sharpening, denoising, brightness adjustment, detail enhancement, and image cropping and rotation.

10. The system for negative-film illumination contour-enhancement imaging as claimed in claim 9, further comprising:
an optimized image generation unit, configured to generate a resultant image from the final optimized image, determine generation parameters before the resultant image is generated, and obtain the resultant image corresponding to the final optimized image after the generation parameters are determined, wherein the generation parameters comprise an output format, an image resolution, and a color mode.
